(19) United States
(12) Patent Application Publication
(10) Pub. No.: US 2006/0026082 A1
(43) Pub. Date: Feb. 2, 2006

(54) Method for processing account information using network

(76) Inventor: Jung-Ho Han, Seoul (KR)

Correspondence Address: FLESHNER & KIM, LLP, P.O. BOX 221200, CHANTILLY, VA, 20153, US

(21) Appl. No.: 10/529,883

(22) PCT Filed: Sep. 9, 2003
(86) PCT No.: PCT/KR03/01880

§ 371 Date: Apr. 1, 2005

(30) Foreign Application Priority Data
Oct. 4, 2002 (KR) 10-2002-00960409

(51) Int. Cl. G07F 19/00; G06F 7/00; G06F 15/167; G07B 17/00; G06F 17/00

(52) U.S. Cl. 705/30; 707/100; 709/213

(57) ABSTRACT

The present invention relates to an accounting information processing method using a wireless communication network, and in particular to an accounting information process method using a wired communication network which is capable of classifying an accounting information input work into a work which may need an accounting knowledge and a work which may be performed without an accounting knowledge and is capable of implementing an accounting information generation work based on the internet by a plurality of part time workers who do not have an accounting knowledge with respect to an accounting information input work or who are capable of performing an accounting work at home.

### TECHNICAL FIELD

The present invention relates to a method for processing account information using a wired or wireless communication network, and in particular to a method for processing account information in which account information input work is classified into a work that needs account knowledge and a work that does not need account knowledge, wherein account work is performed by part time workers using network such as the Internet capable of performing account work at home (here, part time worker represents people who do not have professional account knowledge or people who are not belonged to a certain company and are capable of working account work at home or people who want to do account information input work).

### BACKGROUND ART

Generally, in a management of countries and companies, an account related work is necessarily performed. However, since the end of 1990s, people who can do account-related work are in need.

The lack of accountant is a big problem, but there is not a proper way for increasing the number of accountant within a short period. Therefore, it is preferred to maximize the productivity using the current accountants.

The conventional account work may be classified into a work that needs account knowledge and a work that can be done without account knowledge. Therefore, people who do not have account knowledge, so that it is possible to maximize the productivity of accountant, may perform the work that does not need account knowledge.

As people who do not have account knowledge, there are young people such as university students and women who graduated from the university for processing account work.

The program designed to utilize people who do not have account knowledge on the network such as the Internet has not been actually developed for the reason that there is a fixed idea that people who do not have account knowledge cannot perform input work in account field.

Therefore, as the wired or wireless technologies such as the Internet are advanced, the inventor of the present invention has obtained some facts that work for simply inputting some evidence-related documents in the account input work are a simple work process that does not need account knowledge. In the account work, account information work is simple and does not require a professional judgment based on the account knowledge. In addition, when a plurality of simple part time workers are needed, it may be possible to fast and conveniently do account (taxation) input work. Accordingly, it is an object of the present invention to provide a method for processing account information using wired or wireless communication network.

It is another object of the present invention to provide a method for processing account information using wired or wireless communication network that is capable of classifying account information input work into a work needing account knowledge and a work that does not need account knowledge wherein people who do not have account knowledge and are collected on the internet work simple work on the Internet that does not need account knowledge.

### DISCLOSURE OF INVENTION

The present invention relates to a method for processing account information using wired or wireless communication network, and the preferred embodiments of the present invention will be described with reference to the accompanying drawings.

FIG. 1 is a diagram illustrating the construction of a system of an account information processing method using a network according to the present invention, FIG. 2 is a diagram illustrating the construction of a central server of a mediator of the system according to the present invention, FIG. 3 is a diagram illustrating the construction of a customer server according to the present invention, FIG. 4 is a flow chart of an account information generation process based on an account process program and an evidence document recognizing program according to the present invention, and FIG. 5 is a diagram illustrating the construction of a work screen displayed on a terminal of an part time worker according to the present invention.

As shown in FIG. 1, the system according to the present invention includes a central server (10) of a mediator, a website (20) cooperating with the central server (10), a customer server (40) and an part time worker terminal (30). The central server (10), the customer server (40) and the part time worker terminal (30) are connected with a wired or wireless network through the website (20) for thereby transmitting and receiving information.

The part time worker terminal (30) is an apparatus for connecting with the customer server (40). The part time worker terminal (30) may be formed of a personal computer, a personal digital adapted (PDA), a cellular phone, etc. Here, the part time worker terminal (30) is connected with the customer server 40 using the part time worker terminal (30) and performs an account work. During the account work, the work screen (FIG. 5) of the account process program (42) stored in the customer server (40) is displayed on the work screen.

Here, the part time worker represents a person who performs an account work provided by the customer and receives a certain amount of money. The part time workers are classified into a certain group based on a knowledge level with respect to account work, an account work processing performance and evaluation by customers. The part time worker may represent a person who does not have knowledge concerning account work but may represent a person who wants to work at home and has account knowledge. The part time worker may be evaluated based on a processing speed and amount of account work and completeness of account work, while performing a certain account work. A result of the evaluation may be a basic material for determining the level of the part time workers. The part time worker may receive a certain amount of money determined based on his level. When the level of the part time worker is below a certain level, the part time worker may be fired in a certain firing system. In the above firing system, if a certain part time worker receives the lowest point less than a certain point by a certain number or the accumulated average point is smaller than a certain point, a corresponding part time worker may be limited in doing the account work or may be fired forever. The accumulated average points or records of account work may be stored in an part time worker information database (18) that is automatically performed by the account work management unit (12).

FIG. 2 is s diagram illustrating a central server (10) of the mediator according to the present invention. The central server (10) includes a database (16)(18) for storing customer information and part time worker information, an account work management unit (12) for receiving and distributing account work, and a verification program (14).

The database (16)(18) of the central server (10) stores information of the customer and information of the part time worker and transmits and receives information with the account work management unit (12).

The customer information includes a customer's common information such as name (company name) of a customer, contact information, address, etc. and information of the customer server (40) (URL information of the customer server, etc.) and payment information such as a payment method, and account work information.

The part time worker information includes common information such as a name, address, contact information, etc. of the part time worker, an account work knowledge level, part time worker level, etc.

The account work management unit (12) performs a customer's account work application receipt, an account work distribution with respect to part time workers, an account work process and a reservation management of a work distribution application, and a performance and level evaluation management of the part time worker.

The account work distribution with respect to the part time workers by the account work management unit (12) is performed in such a manner that information with respect to the account work disclosed in the website (20) and the account work distribution application are received from the part time workers, and then the account work is distributed to the part time workers based on a certain method.

Basically, the method for distributing the account work is performed in such a manner that the part time worker who first applied the distribution of the account work receives the account work based on a process completion request time of the account work provided by the customer, the account work process possibility time and the work time of the part time worker. In the case that a plurality of customers request the account work processes at similar time, it is preferred to first distribute the part time workers to the customer who first requested the account work in the website (20). In particular, in the case that a plurality of customers designate a specific part time worker, the part time worker is first distributed to the customer who first requested the account work.

When the account process work is distributed, a reservation-based distribution method may be used. Namely, as other method of the account work distribution method with respect to the part time worker, in the case that the customer and the part time worker previously reserve the account work providing time and possible time, the account work is first distributed to the reserved account work. According to the above reservation method, the customer transfers the name, work amount, and desired completion time of the account work to the account work management unit (12) for thereby reserving the account work. The part time worker can make a reservation by transferring the work possible time for doing the account work, work time and work amount. The account work management unit (12) reviews reservation information of the customer and part time worker and selects the part time workers who can do the account work based on a reservation sequence and distributes the account work. The work amount of the account work represents the amount of the evidence documents to be processed.

The account work management unit (12) performs a performance management of the part time worker and accumulatively manages a work amount, work completion time, customer's evaluation, and other related information for the use in the future when the level of the part time worker is determined or the part time worker is fired.

The verification program (14) cooperates with the account work management unit (12) and compares the information of the customer information database (16) and the part time worker information database (18) with an inputted information when the customer and part time worker need a verification through the website (20) and confirms a matching state between the customer and the part time worker for thereby performing a verification.

The customer server (40) includes a control unit formed of a database (46)(48) for storing an evidence document image information and account information, an account process program (42), and an evidence document recognition program (44).

The customer may be an individual, a department related to an account work of a company or an accountant office, and a tax accountant.

Here, the evidence document image information represents image files produced by scanning an evidence document for accounting work using a scanner or photographing the same using a digital camera The evidence documents are various bills, credit card receipt, temporarily tax bill, receipt by cash register, etc. The evidence document is made in an image file and is stored in the evidence document image information database (46).

The account information is a resultant material obtained by processing the evidence document image information using the account processing program (42) and the evidence document recognition program (44). The part time worker stores the same into the account information database (48) of the customer server (40). In addition, the account processing information may be produced by processing the account information using the evidence document image information based on the customer's account work request. The account processing information is stored into the account information database (48).

The evidence document recognition program (44) performs a function for converting the evidence document image information into the evidence document text information. FIG. 4 is a diagram illustrating the process for generating an evidence document text information and an account information based on the driving (100)(200) of the account processing program (500) and the evidence document recognition program (510). The evidence document text information generating process is formed of a position recognition process (520), a content recognition process (530), a thinning process (540), and a text analyzing process (550). When the text analyzing process (550) is completed, the evidence document text information generating process (560) and the text information list generating process (570) are performed and seen on the work screen (42). The text information list is stored in the account information database (48) as account information in the account information generating process (580).

The position recognition process (500) is adapted to search the positions of date, company name, application, money amount, etc. of the evidence document needed for the account processing information generation in the evidence document image information.

In the case that the standard form such as tax bill, temporarily bill, etc. that is one of the evidence document, the position of a corresponding item is searched based on the previously determined coordinates. Since the credit card receipt has different forms by the payment company (the number is about 20), a logo or specific image of the payment company formed on the upper side of the receipt is memorized, and the position information (position of necessarily element for account process) based on the credit card form of each company is previously set, and the coordinates X, Y and Z are memorized based on the reference point and are recognized. Since the cash register receipt and other receipts have different forms and shapes, a specific color or mark (V, *, #) is indicated by the customer in the left side in which the data, money account, company name are formed, is scanned, so that the scanned images are used as a recognition symbol with respect to the region during the position search.

The content recognition process (530) is a process in which the region having information such as text or number in the position of a corresponding item in the position recognition process and the contents of the same are recognized. When recognizing the contents of the region, a pattern and text are recognized, and a form line and text are recognized.

The method for recognizing the pattern and text will be described.

The recognition of the pattern and text is performed by measuring the brightness of each region. When the brightness of a corresponding region is 1, or there is a significant difference in the brightness as compared to the surrounding brightness, it is possible to judge that a certain region is a text region in 100%. At this time, the significant difference may be expressed in detailed number. The number may be variably applied based on the average brightness (entire brightness) between the text region and the background region.

As a result of measuring the brightness in the image file of the evidence document image information, a region that may be recognized as a text region within 5 point distance is not searched, the region may be recognized as a pattern because in the case that the region is scanned by 15 dpi, the 5-point distance may have a significant meaning. Namely, it is judged that the region having no dark region within 5-point distance may be recognized as a pattern based on the facts that there is a determinable text region within 5-point distance with respect to the text of brightness (level 3) as compared to the background.

The method for recognizing the form lines and the text with respect to the regions recognized as the text, not pattern will be described. The recognizing process of the form line and text is directed to easily recognizing the texts needed for the account information process by deleting the data with respect to the form lines by searching the form lines from the text portion, not pattern portion. The evidence document image information has a brightness value corresponding to the coordinates X and Y of the position region. Therefore, deleting the data with respect to the form lines represents that the brightness value of the portion corresponding to the form lines are changed to the brightness value of the background portions. Therefore, it may be possible to more easily recognize the texts in the following text analysing process (550).

Next, in the case that there is a significant difference between the color of the form line and the color of the text portion, for example, in the case that the elements of the red color is significant, and it is not in the text portion in the form lines, the portion having clearer red is recognized as the form lines, so that the data corresponding to the form lines are deleted.

The case that it is impossible to recognize the color of the form lines and the color of the text portions will be described. First, the recognition of the horizontal line and text in the form lines will be described. It is searched whether there is a horizontal line having the text portion by more than 90% from 1 of the coordinate Y to 1 of the coordinate X in a corresponding position region. In the case of the form lines, it may be recognized as the text portion 100%. Recognizing the region as the form lines in 90% is to provide a certain tolerance.

The regions of +−2 point on the coordinate Y in the up and down directions is searched with respect to the searched horizontal line. The regions belonging to one horizontal line and body are searched for thereby determining the up and down point range of the horizontal line. When the portions of the horizontal lines are protruded by more than 2-points in the up and down ranges of the horizontal lines in the left or right directions, or the portions are protruded by more than 2-point in the downward direction or the portions are concurrently protruded by more than 1-point in the up and down directions, the portions of the horizontal lines correspond to the up and down connection portions, so that the portions of the same are not deleted.

In the case that the region is protruded from the up and down ranges of the horizontal line by only 1 point in either the up or down direction, when an up and down connection portion is seen within the surrounding 5-point range, the portions are not deleted. The protruded portions may be recognized as the region included in the horizontal line, so the protruded portions are deleted. In addition, when the regions of the up and down 2-points are empty except for the up and down ranges of the horizontal line, the portions represent a true horizontal line passing point, so that the up and down ranges of the horizontal line are deleted.

The recognition of the vertical line and the text will be described.

The above recognition is achieved in the same manner as the horizontal line method. However, in the vertical lines, the vertical lines of the center portion of the position region may be texts, only the vertical lines in the left and right sides are checked. In addition, the portions are recognized as the vertical lines by 100% only when the portions pass through vertically. The ranges determined as the vertical lines are deleted in the same manner as the horizontal lines.

The recognizing method between the text the background will be described.

For recognizing the text and background, the form lines are searched, and it is recognized whether a certain portion corresponds to the background in the region having content in the form lines, or the portion corresponds to the text. The method for recognizing the text and the background is directed to computing the brightness of a boundary between the text and the background based on a statistical analysis of the brightness distribution and recognizing the portion having the brightness higher than the boundary line as the text portions in consideration with the brightness with respect to the surrounding portions.

The thinning process (540) will be described.

The thinning process (540) is a process in which the texts recognized as the text portion in the recognition process of the text and the background are converted into a single line.

Namely, the above text is divided into multiple strokes, and each stroke forms a thick line with a plurality of points, so that a single line representing an inherent shape is determined.

The thinning process (540) is formed of a first step for obtaining a cape, a second step for drawing a major axial line, a third step for drawing a detailed axial line, and a fourth step for searching a non-searched region and drawing an axial line.

The first step is directed to obtaining a cape.

The cape represents a point having at least more than 5 blocked directions among eight directions (east, west, south, north, north-east, south-east, north-west, and south west) and a point in which it is impossible to search significantly different two directions. It is searched with respect to all points recognized as the text whether each point corresponds to the cape, and a coordinate X and Y corresponding to the cape is memorized. Here, all points represent the points appearing when increasing the value X to the area from 1 of a corresponding position region and when increasing the value Y with respect to each value X from 1 of a corresponding position region.

The second step is directed to drawing the major axial line.

Namely, the second step is a work step for drawing a line connecting the capes. Namely, when connecting the capes viewed from the text portions, the line has a meaning as a major axial line expressing a schematic construction of the entire shape of the text. Namely, the horizontal line and vertical line corresponding to the column of the text are exposed.

The above process will be descried. The distance between the capes is two times of the average thickness of the stroke of the text. A combination of the capes satisfying the condition for a linear connection is obtained. Here, the linear connection represents that when the linear connection is achieved, the linear line does not pass through the background portion.

Next, since there may be a combination between the capes on one path, a combination having the highest representative is selected among the combinations passing on the same paths. In the case that the line is near the horizontal line or vertical line, a combination having a smaller angle difference between the horizontal line and vertical line is selected. In the remaining other cases, the combination having a longer length is selected. The combinations having the high representative are connected by a straight line for thereby obtaining a major axial line, and the points of the major axial lines are substituted with the black color.

After the major axial line is selected, the coordinates of the capes near the ends of both sides of the major axial line among the coordinate groups of the capes are deleted. Since the capes near the axial lines are used for obtaining the major axial lines, the groups of the capes are deleted for avoiding a certain confusion when obtaining other axial lines.

The third step is directed to drawing the detailed axial line.

The dots remaining in the coordinate group of the capes are the end dots of branches in which the axial lines are not drawn. The following work starts from the above dots, and the text portions are searched until the other end points are met or the major axial lines are met, so that a detailed axial line is drawn on the trace.

The above process will be described in more detail. Namely, since a plurality of capes may be seen near the capes, the neighboring points are collected among the points of the coordinate groups of the capes and are integrated as one representative point. Namely, since the points of the coordinate groups of the capes are a starting point of the searches for drawing the detailed axial lines, the coordinate groups of the capes are integrated into one representative point so that there is only one representative point in the end of each test shaped branch.

Next, each search is performed for drawing the detailed axial lines from the representative points operating as the start points.

The process of the search will be described. First, the straight line is performed with respect to the straight line. Namely, the entire directions of 360° are divided into 64 directions from the representative point (start point or station during the search), and the straight line search is performed in the 64-directions. At this time, the selection reference (priority) of the search direction among the 64-directions is as follows.

First, in the case that the direction meeting with the major axial line is found, the above direction is selected and connected with the found major axial line for thereby obtaining a detailed axial line.

Second, in the case that there is not any direction meeting with the major axial line or it meets with the cape of the other end portion, the above direction is selected, and the detailed axial line is obtained. If there are at least more than two directions meeting with the other side end, the direction having the longer length is selected.

Third, in the case that there is not any direction meeting with the major axial line or the capes of the other end portion, the direction having the longest search distance is selected as the detailed axial line.

The moving direction and target point are selected with respect to the 64-directions from the representative points in accordance with the above reference, and the straight line search is performed. The above process is continued until the major axial line or other capes are met. When the above process arrives at the other cape, and the search is stopped, the coordinate4s o the capes of the arriving points are deleted, so that the above coordinates are not used as the start points.

The fourth step is directed to searching the non-searched region and drawing the axial line.

The portions that the axial line is not drawn may slightly formed throughout the above three steps. In this case, the non-searched regions that are not searched in the second and third steps are searched, and the axial line is drawn for thereby finishing the process.

First, the non-searched regions are searched. For example, the cross section not having the major axial line or detailed axial line is searched among the cross sections of the text portions having a thickness less than 1.5 times of the average thickness of the stroke of the text. The above cross section may be classified into a horizontal cross section and a vertical cross section. The following process is performed with respect to each cross section.

In the case of the horizontal cross section, the axis Y is increased from 1 to the height, and the axial line is obtained through the process of obtaining the detailed axial line in the section from 1 of the axial X to the width. In more detail, the search is continued until the axial line is searched in the direction from north-west to north-east through north in the upper side region based on the process of obtaining the detailed axial line. In the lower side region, the search is continued until the axial line is searched in the process of obtaining the detailed axial line from south-west to south-east through south.

In the case of the vertical cross section, the axis X is increased from 1 to the width. The search is performed with respect to the left and right directions in the same process as the horizontal cross section in the sections from 1 of the axis Y to the height with respect to one X for thereby obtaining the axial line.

The axial lines with respect to all text portions are determined throughout the above four steps.

Next, the process of analyzing the axial line and reading the texts will be described. In the text analysing process (550), the text is read in the sequence of the first sound, middle sound and last sound. It is additionally judged whether the text is Korean, English, numbers, or special symbols for thereby finishing the last reading process.

The reading of the first sound is performed with respect to the texts having the determined axial line. The ranges of the first reading include Korea, number, English, special symbols. The number, English, and symbols may be recognized as the first sound. The first sound does not need the reading of the middle and last sounds.

The large groups of the first sound are determined based on the shapes of the axial lines of the text to be read. The large group of the first sound may be classified into five groups of the horizontal line, vertical line, crossing line of the horizontal and vertical lines, slant line, and circular line in accordance with the shape of the axial line starting from the left upper side with respect to the Korean consonant, number, English, special texts, etc. corresponding to the range of the first sound.

The large groups of which the shape of the axial lines is horizontal line are formed of [symbol] . . . , T, Z . . . , 7”. The large groups of which the shape of the axial line is vertical line are formed of [symbol] . . . , H, I, K, L, U, . . . , 1”. The large groups of which the horizontal line and the vertical line are crossed in the shape of the axial line are formed of [symbol] . . . , B, D, E, F, M, N, . . . , 5”. The large group of which the shape of the axial line is slant line are formed of [symbol] A, . . . , 4”. The large groups of which the shape of the axial line is circular are formed of [symbol] C, G, O, S, . . . , 2, 3, 6, 8, 9, 0”.

Next, the large groups may be divided into the middle groups. In the above middle groups, the first sound belonging to the large group may be classified based on the types of the axial lines. In order to determined the belonged middle groups, “the vertex evaluation”, “closed circle evaluation”, etc. may be performed based on the shapes of the axial lines.

For example, “the vertex evaluation” is performed with respect to the first sound corresponding to the large groups of which the axial line is horizontal line. If the evaluation is successful, the ranges may become [symbol] “The closed circle evaluation” is performed with respect to the large group in which the axial line is circular, if the evaluation is successful, the ranges may become [symbol] O, 8, 9, 0”.

After the middle group is determined, the shape of the axial line of the first sound to be read is compared with the previously set shape of the first sound belonging to the middle group for thereby reading the texts. For example, the [symbol] -evaluation and the [symbol] -evaluation are performed with respect to the vertex middle groups for thereby reading the first sound texts.

The number of texts belonging to the middle group are less than 7 for the fast evaluation.

The verification is directly performed concerning whether a certain text is corresponded with respect to the first sound that is not determined during the grouping process of the large group and middle group. In the case that it is possible to know whether the text to be read is number, Korean, or English, the reading ranges are limited for thereby decreasing time.

The reading process of the vowel of the middle sound will be described.

After the reading of the first sound is finished, it should be determined whether the reading of the middle sound is performed based on the kinds of the first sound. In the following two cases, the reading of the middle sound is started.

First, when the first sound is judged as Korean, the reading of the middle sound is started. Second, when the first sound is confused to judge whether it is Korean or English, it is needed to judge whether the first sound is Korean or English.

In order to read the middle sound, the position of the vowel is recognized using the axial line of the text.

The middle sound of Korean is formed of a clear horizontal line or vertical line or horizontal/vertical lines. Therefore, the clear horizontal line or vertical line is recognized after the thinning process is performed. The position of the vowel near the first sound is recognized during the thinning process.

In the reading process of the middle sound, if the horizontal/vertical line is not found in the right side or lower side of the read first sound, it means that English or number is erroneously recognized as Korean, so that such information is stored, and the first sound reading process is performed again.

After the position of the vowel is recognized, the type of the vowel is recognized.

The dividing type is recognized in detail along the found horizontal line or vertical line, and the vowel is read. For example, the dividing type is recognized in the up and down directions with respect to the horizontal line “-”, and the type of the vowel such as [symbol] is determined for thereby reading the middle sound using a specific text.

The reading process of the middle sound will be described.

After the reading of the middle sound is finished, it is checked whether there is another text portions that are not included for recognizing the first or middle sound in the lower portions in the left and right widths (range of coordinate X) of the position at which the first and middle sounds occupy. As a result of the check, if there is another portion, the text is recognized as the last sound. In the case that the first sound corresponds to Korean, the reading process is performed in the same process as the current process for thereby reading the last sound.

The evidence document text information generating process (560) of forming the text-formed evidence document text information from the evidence document image information using the account process program (42) will be described.

When the part time worker drives the account process program (42) installed in the customer server, as shown in FIG. 5, the screen is displayed on the part time worker terminal (30). The above screen may be divided into five regions.

The five sections are formed of a first region (421) in which evidence document image information stored in the customer server (40) is displayed, a second region (422) in which the drive or path of the customer server (40) storing the evidence document image information is displayed, a third region (423) in which the converted text information is individually displayed, a fourth region (424) in which the converted text information is displayed in a list form, and a fifth region (425) in which the account note of the text information of the text information list is displayed.

The first region (421) is a region for displaying the evidence document image information formed by scanning the evidence document, so that an actual feeling is obtained while viewing the image of the evidence document.

The second region (422) is a region for displaying a drive/path of the customer server (40) for storing the evidence document image information. Therefore, the drive/path in which the evidence document image information needed before the account work is started is designated. When a new evidence document image information (for example, jpg file) is formed in the designated drive/path, the evidence document recognition program (44) capable of converting the evidence document image information into the evidence document text information is automatically driven. In the second region (422), the evidence document image information is generated, and a function capable of controlling the scanned and the generation of the image information is obtained.

The third region (423) is a region for editing the contents wherein the text information of the selected line is displayed on the list of the fourth region (424). Therefore, the contents are compared with the image material displayed in the first region (421) for thereby checking whether the contents of the evidence document are correctly moved. If not correctly moved, the errors are corrected. In the reading process (560) of the evidence document image information by the evidence document recognition program (44), various background colors are provided based on the success state of the reading and the probability of the accuracy for thereby managing the user's cautions.

In the fourth region (424), the text information converted from the evidence document that is not being performed is listed in a line shape. Namely, the evidence document text information read from one evidence document image information is displayed in one line. As shown in FIG. 5, the text information is classified into date, name of company, money amount, and application and is shown in each line. When a desired line is clicked in the list or when a desired line is moved up and down using the arrow, the evidence document image information corresponding to the selected line is displayed in the first region (421), and the evidence document text information converted from the evidence document image information is displayed in the third region (423) in an editable mode.

When a new evidence document image information (for example, jpg file) scanned and stored in the drive/path designated in the second region is shown, the process (560) of reading the evidence document image information as an evidence document text information is automatically performed by the evidence document recognition program (44). An evidence document text information corresponding to one evidence document is automatically formed in the fourth region (424) in one line through the text information list generating process (570).

In the account information generating process (580), the text information list is stored into the account information by the account processing program (42). The account information is stored in a computer file form.

The fifth region (425) is a lump account processing region for converting the account information (note) by account-judging the evidence document text information displayed in the fourth region. Namely, the fifth region (425) is a region for performing a function of designating the contents of the evidence document converted into the text in the dividing form in lump or separately using the functions from the first region (421) to the fourth region (424). In addition, a function of generating an account note in lump based on the dividing form is stored.

In addition, the transaction contents generated in the account note and stored in the account book maintains a certain connection property with the evidence document image information. While the account book is being checked, it is desired to see the evidence document image information, it is possible to see the same based on one click.

The evidence document recognition program (44) concerning the process of reading the evidence document image information to the evidence document text information includes the functions of reading the texts used by Korean people. The above constructions are adapted on the assumption that the account notes are the Korean account notes. The texts of the foreign countries or the evidence document image information of other countries including modified information are also included in the present invention and are within the ranges of the present invention.

The process of the account process method using the network according to the present invention will be described. FIG. 6 is a flow chart of the account process method using a network according to the present invention.

The account process method according to the present invention includes a mediator's central server system constructing step (S10), a mediator's website constructing step (S20), a customer and part time worker verification step (S30), a customer's account work listing step (S40), an part time worker's account work request step (S50), an part time worker selection step (S60), an account information storing step (S70), an account information review step (S80), an electronic payment step (S90), and an part time worker level determination step (S100).

In the mediator's central server system constructing step (S10), there is provided a central server (10) for controlling the entire steps for constructing the central server system, so that the mediator performs the account process method using the network according to the present invention. There are further provided database (16)(18) cooperating with the central server (10) and storing the information of the customer and part time worker. The central server (10) includes an account work management unit (12) for controlling the entire steps according to the present invention transmits and receives the information with the customer server (40) and the part time worker terminal (30).

Since the customer information and part time worker information stored in the database (16)(18) were described in the above operation, the description thereof will be omitted.

The mediator's website constructing step (S20) is a step for constructing the website (20) cooperating with the central server (10) and being connected with the customer server (40) and the part time worker terminal (30). The customer starts the account work in the website (20), and the part time worker can request the account work.

The customer and part time worker verification step (S30) is a step for checking whether the customer's and part time worker's information stored in the database (16)(18) of the central server system (10) are matched with the customer's server information and individual information and part time worker's information connected with the website (20) for thereby verifying the customer and part time worker.

When the customer is connected with the website (20) and inputs a customer's information, the central server (10) reads the customer server (40) and compares the inputted individual information with the information stored in the customer information database (16) and checks whether the customer connected with the website (20) is a member customer or not.

When the customer requests a customer verification to the central server (10) for starting the account work, the verification program (14) of the central server (10) generates a customer's ID number for protecting the discharge of the customer's ID information and provides to the customer. Therefore, the customer can start the account work in the website (20) using the customer's ID number, not the customer's actual name. Therefore, the customer is capable of preventing the discharge of his information. The customer's ID number may be generated by combining the serial number, verification date, and name of customer based on a sequence of customer who requests the verification. For example, first two digits in the serial number and verification data and English name of customer may be combined.

The part time worker is connected with the website (20) and inputs individual information of the part time worker. The central server (10) compares the inputted individual information with the information stored in the part time worker database (18) and checks whether the part time worker connected with the website (20) is a member or not.

The customer's account work listing step (S40) is a step for listing the account work requested by the customer on the website (20). The website (20) includes a list and completion requested date of an account work, and an part time worker's level and other information needed for performing the account work. The related evidence document image information list is included in the list of the account work.

Therefore, the customer stores the evidence document image information needed for processing the account work into the customer server (40) before the account work is listed in the website (20). The evidence document image information is an image file made by scanning the evidence document related with the account work using a scanner or by photographing the same using a digital camera and is stored in a certain drive of the customer server (40).

The customer lists other information such as the account work requesting date, desired completion date, estimated completion time, requirements for part time workers, etc. for fast requesting the account work that is predicted in short period using the reservation system. In this case, the customer will be provided with the part time workers at the desired time earlier than the other customers.

The account work requested by the customer generates the evidence document text information from the evidence document image information and reviews the errors for thereby generating a text information list. The account process such as a preparation of account note may be performed using the text information list based on the account work processing level of the part time workers.

The part time worker's account work requesting step (S50) is a step in which the member registered as the part time worker through the website (20) requests the distribution of the account work. The part time worker requests the distribution of the account work together with the information such as an account work processing possible period, work time and work amount. The part time worker can previously register the period for processing the account work, work time, work amount, etc. and can make a reservation for the account work. In this case, the account work management unit (12) first distributes the account work to the above part time worker.

In the part time worker selection step (S60), the account work management unit (12) of the central server (10) selects the part time workers who do the account work listed by the customer in accordance with information with respect to the account work listed by the customer and information of the account work request of the part time worker.

The completion time of the account work listed by the customer is compared with the possible period and work time of the account work of the part time worker. The part time worker who first requested the account work is selected as the part time worker to do the account work.

In the case that the customer or part time worker makes a reservation using the reservation system, the account work or part time worker are first assigned.

In the case that the customer sets an additional condition such as the level of the part time worker, when selecting the part time workers, the level of the part time worker is considered, and the account work is first assigned to the part time worker who satisfies the above requirements.

In the process of listing the account work, the customer can designate a certain part time worker to do the account work. Namely, it is possible to designate a certain part time worker who processed the account work of a corresponding customer before or a certain part time worker among the part time workers requested the distribution of the current account work in the website (20) for thereby effectively performing the customer's account work.

The part time worker who was selected for doing the account work listed by the customer will receive an assignment and the lists of the account work to be done from the account work management unit (12). In the case that the part time worker requests the process of the account work, the account work management until (12) transfers the information of the customer server (40) to the part time worker, so that the part time worker is connected with the customer server (40).

The part time worker's account work information storing step (S70) is a step in which the account work requested by the customer is processed and stored in the customer server (40) as the part time worker is connected with the customer server (40).

The part time worker is connected with the customer server (40) through the internet network of the website (20) using the information of the customer server (40) from the account work management unit (12) of the central server (10), by which it is possible to connect the customer server (40). The text-based account information is generated from the evidence document image information by driving the account processing program (42) stored in the customer server (40). When the part time worker drives the account process program (42) and selects a corresponding evidence document image information, the evidence document recognition program (44) is automatically driven, and the evidence document image information stored in the customer server (40) is converted into the evidence document text information. The process of converting the evidence document image information into the evidence document text information is automatically performed based on the processes of FIG. 4. The above processes were described in the above. The evidence document text information is stored in the text-based account information.

The account work process that the part time worker performs using the account process program (42) will be described. The drive/path is designated using the second region of FIG. 5, and the evidence document image information file to be processed among the scanned evidence document image information is selected. The selected evidence document image information is automatically converted into the evidence document text information by the evidence document recognition program (44) and is displayed in the fourth region (424) in one line. A plurality of lines are displayed in list form based on the number of the evidence document image information. When a certain line is selected among the lists, the text information content of a certain line is displayed in the third region (423). The contents of the text information may be editable. The evidence document image information of the selected line is displayed in the first region (421). The part time worker checks whether the image information is accurately converted into the text information. In the case that there is an error in the reviewing step, the contents of the third region (423) is edited and corrected. When the verification with respect to the accuracy of the text information conversion of the image information is completed, a result of the same is stored into one file as the account information. Namely, a plurality of evidence document image information is listed as the evidence document text information and is stored in the account information file.

In the case that the requested account work requests an additional formation of the account note, the part time worker performs a designation needed for the account process (journal) in the fifth region (425) and converts the contents of each line of the list into an account note. The account process is performed based on the journal designation with respect to the account information in which the conversion is completed. The necessary designation represents a lump designation or individual designation. The text information of the third region (423) is converted into the account note based on the designated journal form and is stored as the account process information.

When the part time worker finishes the process of the assigned account work, the generated account information are account process information are stored in the account information database (48) of the customer server (40), and the connection with the customer server (40) is ended. The lists and time of the account work processed on the website (20) are stored.

The account information reviewing step (S80) is a step in which the customer reviews whether the account work is properly processed with the account information that the part time worker processes the account work and stores the processed account work.

When the part time worker finishes the account work requested by the customer and inputs an account work completion into the central server (10), the central server (10) informs the customer of the completion of the account work. The customer receives the completion notice and review the account information stored in the account information database (48) of the customer server (40) by driving the account process program (42). At this time, the customer may review the entire portions of the processed account information or may sample a certain amount of evidence document image information. As a result of the review by the customer, if there are many errors, the customer transfers the result of the review to the central server (10) and requests a reprocess of the account work. The central server (10) requests a reprocess with respect to the account work that needs a reprocess, to the part time worker who processed the account work. The above account is not classified as the finished account work. As a result of the review by the customer, if there is a small error, the customer directly corrects the errors and stores again.

As a result of the review by the customer, if there is not error, the customer transfers the completion of the review with respect to the account work and the process completion of the account work to the central server (10). When the customer transfers a result of the review, the customer may send an evaluation with respect to the work performance of the part time worker who did the account work. A result of the work performance of the part time worker is used as a basic material for determining the level of the part time worker performed by the central server (10).

The customer registers the review work of the account information review step (S80) into the website (20) as a separate account work like a new account work, so that other part time workers can perform the review work.

In the electronic payment step (S90), the central server (10) that receives a result of the review by the customer and a process completion of a corresponding account work requests the payment of the cost with respect to the payment method of the customer for thereby performing the payment. The above payment is performed by requesting the payment to the customer using the wired or wireless network in the central sever (10).

The central server (10) pays money to the part time workers who did the account work. The method for giving the part time workers money may be classified into a method of paying money for each case of the account work, a method of paying money at one time based on the accumulated performance during a certain period. A certain method between the above two methods may be selected based on a contract with the part time worker.

In the part time worker level determination process (S100), when the account work management unit (12) finishes the account work requested by the part time worker, the levels of the part time workers are determined based on the information such as part time worker's account work processing performance, account knowledge, etc. In the level determination of the part time worker, the level of the part time worker may be determined when the accumulated points exceed a certain point by accumulating the points given to the part time workers when the part time workers do the account work and finish the same. The points of the part time workers are determined based on the basic points per account work and are decreased or increased by providing weights based on the difficulty or amount of the account work and work time. In addition, the customer evaluates the account work done by the part time worker, and a result of the evaluation is stored in the information of the part time worker and is reflected to the level determination process of the part time worker. When the customer provides a customer evaluation point exceeding a customer basic point with respect to the account work done by the part time worker, a difference between the customer basic point and the customer evaluation point is reflected to the evaluation point. In addition, a certain weight may be provided to the evaluation point in accordance with the part time worker's knowledge with respect to the account work. The level of the part time worker is classified into a common member and a high class member. The common member and high class member may be classified into a detailed level. The levels of the part time workers are used as a basic material such as money payment with respect to the assignment of the account work and account work process in the future. Therefore, it is possible to pay money differently in accordance with the levels of the part time workers. When a certain part time worker continuously maintains a good level, increased money may be given to the part time worker as compared to other part time workers based on an incentive system.

### BRIEF DESCRIPTION OF THE DRAWINGS

The present invention will become better understood with reference to the accompanying drawings which are given only by way of illustration and thus are not limitative of the present invention, wherein;

FIG. 1 is a diagram illustrating the construction of a system of an account information processing method using a wired or wireless communication network according to the present invention;

FIG. 2 is a diagram illustrating the construction of a central server of FIG. 1;

FIG. 3 is a diagram illustrating the construction of a customer server of FIG. 1;

FIG. 4 is a flow chart of an account information generating process based on an account process program and an evidence document recognition program;

FIG. 5 is a diagram illustrating the construction of a work screen displayed on a terminal of an part time worker; and

FIG. 6 is a flow chart of an account process method using a wired or wireless communication network according to the present invention.

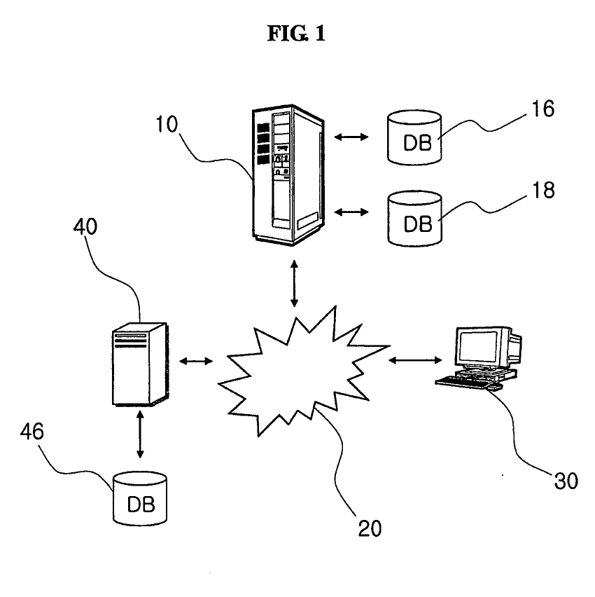

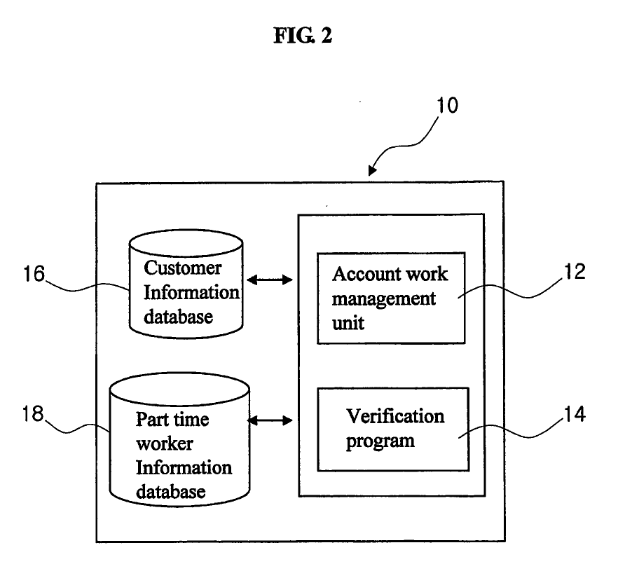

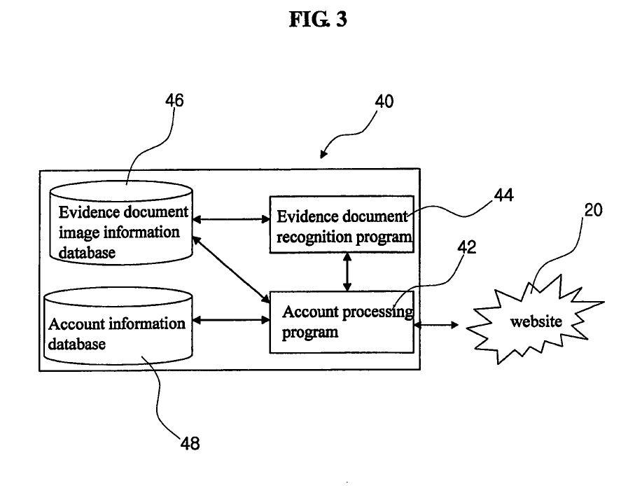

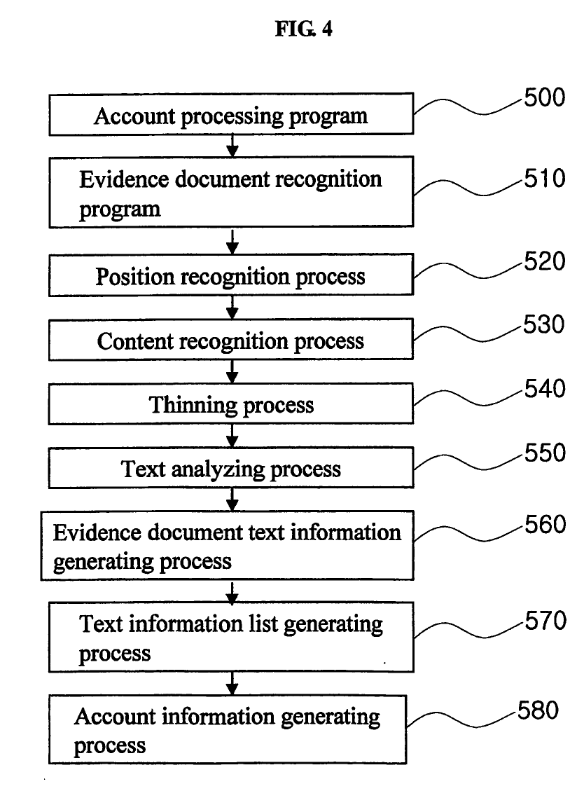

<Descriptions of reference numerals
of major elements of the drawings>

| | |
|---|---|
| 10 - central server | 20 - website |
| 30 - customer server | 40 - part time worker |

### Preferred Embodiment

The preferred embodiments of the account work processes according to the present invention will be described.

The tax/account service office A that is a member registered in the account processing method using the wired and wireless communication network according to the present invention receives a member verification on the website (20) cooperating with the central server (10) of the mediator and lists the contents of the account work to be requested to the part time worker, the evidence document image information list, a desired completion time, and other request information on the website (20). At this time, the customer converts the evidence documents needed for performing the account work into an image file using a scanner or digital camera, and the evidence document image information is stored in the evidence document information database (46) in the customer server (40). When the customer makes a reservation for requesting the account work that will be produced within a short period, the evidence document image information is generated and stored by the reserved date.

The part time worker member is connected with the website (20) and checks the account work listed in the website (20) and requests the assignment of the account work to the central server (10) for thereby receiving the account work. The account work management unit (12) of the central server (10) distributes the account work or part time worker in a sequence of the list or request in the case that there are a plurality of account works requested by the customer or a plurality of account work requests by the part time workers. The central server (10) compares the account work completion date and work amount requested by the customer and the work possible period and work time of the part time worker. The account work is distributed to the part time worker who can complete the account work within a requested date. The central server (10) computes the estimated time needed for processing the account work in consideration with the time needed for processing the account work corresponding to the amount of the evidence document to be processed and one evidence document. Therefore, the central server (10) selects the part time workers who can satisfy the customer's desired completion date by considering the work possible time and work time of the part time workers. The part time worker inputs his ID and password into the part time worker terminal (30) cooperating with the central server (10) and is connected with the central server. The person who first connects as an part time worker inputs a personal ability information and individual information such as account knowledge level, resident registration number, address, telephone number, etc. and requests his ID and password. Namely, the inherent ID and password of the part time worker are requested for thereby implementing a subscription of the account work and receiving information needed for the request of the account work.

In the case that the customer previously made a reservation, the part time worker is first assigned to the account work of the customer who made the reservation. In the case of the part time worker, the account work is first assigned to the part time worker who made the reservation. The central server (10) transfers the verification information capable of connecting the customer server (40) to the assigned part time worker.

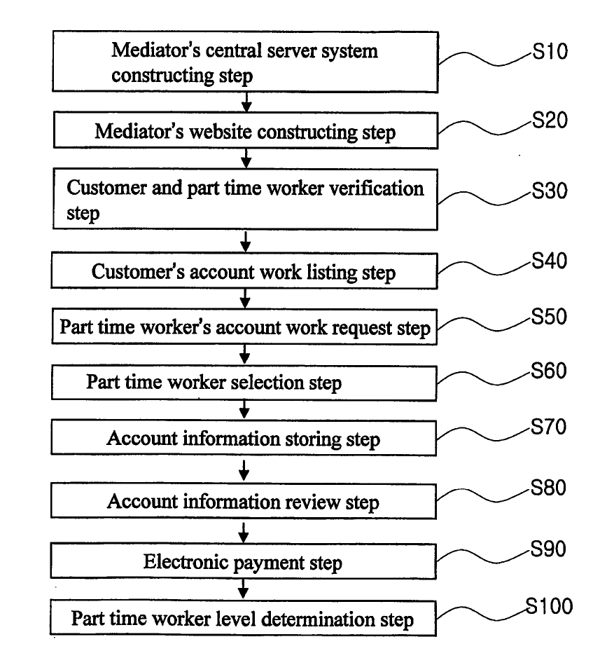

The part time worker who received the account work is connected with the customer server (40) using verification information received from the central server (10). After the part time worker is connected with the customer server (40), the evidence document image information is first checked, and the account process program (42) is driven. When the work is displayed like the work screen of FIG. 5, the part time worker who received the account work performs work for converting the evidence document image information into the evidence document text information. When the evidence document image information is selected from the drive of the customer server (40) in which the evidence document image information is stored, the evidence document recognition program (44) is automatically driven, and the evidence document image information is converted into the evidence document text information and is displayed in the document information list region of the fourth region (424) of the work screen of FIG. 5. In addition, the converted document information is separately displayed in the third region (423). The document information displayed in the third region (423) is compared with the content of the evidence document image information. It is checked whether the conversion into the text information is correct or not. If there is an error, the error is corrected. The account information based on the process of the account work is stored in the account information database (48) of the customer server (40), and the connection with the customer server (40) is ended and returned to the website (20). The list of the account work and the process time of the account work are recorded.

When the part time worker reports the completion of the account work, the central server (10) requests the review with respect to the completed account work to the customer (tax/account service office A). The customer reviews a result of the account work when the completion report of the account work is received from the part time worker through the website (20). A result of the review is transferred to the central server (10). If the evaluation by the customer is successful, the central server (10) transfers the contents that the account work is completed to the part time worker through the part time worker terminal.

The central server (10) requests the payment of the cost with respect to the completion of the account work to the customer and pays money to the part time worker. The central server (10) stores a result of the evaluation with respect to the part time worker and the account work process performance into the part time worker information database (18) of the central server (10). In addition, if it is needed to adjust the level of the part time worker, the level is adjusted and stored.

In the above embodiment of the present invention, the process that the customer's account work is performed by the part time worker on the website (20) cooperating with the central server system (10). The above described process is sequentially performed based on the account work process by one part time worker. The above account work may be performed by a plurality of part time workers. In addition, the account work may be implemented in such a manner that a global-based wired and wireless network connectable with the website (20) cooperating with the central server (10) is constructed. In addition, it is possible to process the account work in any place in which the part time worker terminals (30) are installed for performing the account work using the evidence document image information needed for the process of the account work from the customer server (40). Therefore, in the present invention, it is possible to do an account work using low cost workers in any place on the earth, so that the account work processing method using a network according to the present invention is not limited to the local area. Namely, it is possible to do the account work using a global-based wired or wireless network in any place in the world.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

As described above, the part time workers collected on the internet do the account information input work in which the evidence document information needed for the account process in the account work is changed into the text information and is stored. Therefore, the accountant does work only high level accounting work, so that it is possible to increase the productivity of the accountants more than 5 times. Therefore, it is possible to basically overcome the lack of accountants what have been a problem since the end of 1990s. Namely, since it is possible to perform account work more than 5 times using the current accounting manpower, it is possible to overcome the lack of accountants. In addition, in the present invention, since it is possible to use low cost workers in other countries for doing account work, the lack of accountants is overcome.

In the present invention, the process for converting the evidence document image information performed by the part time workers into the evidence document text information is performed using the evidence document recognition program (44), so that it is possible to effectively perform the account work.

In the present invention, the part time workers may do account work in any place connectable with the Internet such as home or school, so that the account work is effectively performed.

In addition, the part time workers do account work and receive money and a level based on the performance of the account work. Therefore, the part time workers are first provided with the account work, level-based different money, etc., so that the part time workers can more diligently do the customer's account work, and the customer may be provided with better quality of account work service.

1. A method for processing account information using network, the method comprising steps of:
verifying a customer or part time worker in which the customer or part time worker who is connected with the website are verified by comparing a customer information or part time worker information inputted with a customer information or part time worker information registered and stored in the database;
entrusting an account work in which an account work trust information of the customer is listed in the website;
applying for an account work process in which an application information for an account work process of the part time worker is listed in the website;
selecting an part time worker in which most suitable part time worker is selected for performing the account work by comparing an account work trust information of the customer with an account work application information of the part time worker; and
storing an account information in which the selected part time worker connected with the account process program of the customer's server through the part time worker's terminal converts the evidence document image information into an account information and stores it in the account information database.

2. The method of claim 1, wherein the said step of storing account information includes:
the step in which the evidence document image information stored in the customer server is converted into an evidence document text information by an evidence documents recognition program; and
the step in which the account process program lists the contents of the evidence document text information and generates an account information.

3. The method of claim 1, wherein the said step of verifying customer includes the step for providing a customer identification (ID) number in which the central server generates a customer ID number and provides to the customer for preventing a revealing of the customer information.

4. The method of claim 1, further comprising the step of reviewing account information in which the customer reviews the account information stored by the step for storing account information.

5. The method of claim 4, further comprising the step of correcting an account information in which as a result of the review of said account information review step, in case that there is an error in the account information, the error in the account information is corrected and stored by the account process program.

6. The method of claim 5, further comprising the step of re-entrusting an account work in which as a result of the review of the account information review step, in case that there is an error in the account information stored by the part time worker, said account work is re-entrusted as a new account work on the website.

7. The method of claim 4, thither comprising the step of an electronic payment in which the central server that receives a completion of the account work from the customer server requests a cost payment to the customer server through the network, so that the cost payment is performed.

8. The method of claim 7, further comprising the step of determining an part time worker level in which the central server determines an part time worker's level based on an information concerning an part time worker's account work process performance, an account knowledge state, etc.

9. The method of claim 1, wherein the said evidence document image information is a digital image file produced in such a manner that a tax bill, credit card receipt, temporarily tax bill, cash register receipt, etc. which are needed for a common account process are scanned using a scanner or are photographed using a digital camera.

10. The method of claim 1, wherein the said account work is converted into one account information file in such a manner that the part time worker lists a plurality of evidence document image information stored in the customer server into an evidence document text information using the account process program for thereby generating one account information file.

11. The method of claim 10, wherein in the said account work, the listed evidence document text information is account-processed based on the journal form of the account process for thereby generating account process information.

12. The method of claim 1, wherein the said account process program provides an account work screen on the part time worker terminal, and said work screen includes an evidence document image information region, an evidence document text information correcting region, an evidence document text information list, and an account process region.

13. The method of claim 1, wherein the said step of converting the evidence document image information into an evidence document text information; further comprising the steps of:
recognizing the positions of items such as date, company name, money amount, summary, etc. needed for the account work;
recognizing form lines and text portions in the above position;
recognizing the text portions and a background portion;
thinning by expressing the text portions formed of a thick line into a single line representing the shape; and
analyzing the motion and shape of the single line and decoding the text.

14. The method of claim 1, wherein the said step of selecting the part time worker, a customer's desired account work completion time and the amount of the account work are compared with the part time worker's account work processing possible time and work time for thereby selecting an part time worker who can do the account work.
